(19) United States
(12) Patent Application Publication
(10) Pub. No.: US 2016/0110086 A1
(43) Pub. Date: Apr. 21, 2016

(54) GRAPHICAL INTERFACE TO EDIT THRESHOLDS

(71) Applicant: HEWLETT-PACKARD DEVELOPMENT COMPANY, L.P., Houston, TX (US)

(72) Inventor: Jean-Charles Picard, Grasse (FR)

(21) Appl. No.: 14/892,674

(22) PCT Filed: Jun. 21, 2013
(86) PCT No.: PCT/IB2013/001680

§ 371 Date: Nov. 20, 2015

(51) Int. Cl. G06F 3/0484; H04L 12/24; G06F 3/0488

(52) U.S. Cl. CPC G06F 3/04847; G06F 3/0488; H04L 41/5006; H04L 41/5035

(57) ABSTRACT

Example embodiments disclosed herein relate to a graphical interface for editing threshold values. Display of the graphical interface is caused. The graphical interface shows a multiple ranges along a first axis and multiple threshold manipulation tools corresponding to the ranges. The threshold manipulation took are further adjustable along a second axis perpendicular to the first axis.

### BACKGROUND

Service providers and manufacturers are challenged to deliver quality and value to consumers, for example by facilitating the use of applications. Applications can interface with users via a graphical user interface. The graphical user interface can improve the user's experience with the application.

### BRIEF DESCRIPTION OF THE DRAWINGS

The following detailed description references the drawings, wherein;

FIG. 1 is a block diagram of a system capable of editing thresholds of ranges, according to one example;

FIG. 2 is a block diagram of a system capable of editing thresholds of ranges as well as adjusting ranges, according to one example;

FIG. 3 is a flowchart of a method for editing thresholds, according to one example;

FIG. 4 is a block diagram of an example user interface for editing thresholds and showing ranges, according to one example;

FIG. 5 is a block diagram of an example user interface for editing thresholds and showing ranges, according to one example;

FIG. 6 is a block diagram of an example user interface for editing thresholds and showing ranges, according to one example; and

FIG. 7 is a block diagram of a computing device capable of causing display of ranges and for editing thresholds, according to one example.

### DETAILED DESCRIPTION

There are various uses for graphical user interfaces in today's world to interact with applications or programs. For many applications and uses, a lot of ranges or values are defined. For example, in the context of service level agreement (SLA) management, ranges/values of SLA objects (e.g., clause objectives, service level objectives, business impact or penalty, etc,) may need to be entered or modified. In some example, SLA is a part of a service contract where a service is formally defined (e.g., for a contracted delivery time, a time between failures, time to repair, time to recovery, data rates, etc.) As such, it can be beneficial to provide a more friendly approach to entering these values instead of static entering of numerical values into fields, For SLA management providing several levels of offerings for services (e.g., gold, silver, bronze, etc.) to customers, these values can be globally adjusted to a correct level.

Accordingly, various embodiments disclosed herein relate to a graphical interface to allow an easy, simple, and unified approach to define thresholds for an application. This can allow for a powerful tool that enables a quick view of information as well as capabilities to quickly change thresholds for the information. Various examples herein are associated with service level agreement management, however, it is contemplated this approach can be used to enter threshold values for other uses. The graphical interface can include, for example, widgets, controls, other appropriate user interface elements, combinations thereof, etc.

The interface allows association of a threshold value a numeric value, a percentage, etc.) to a range defined by enumeration or ranges specified by minimum/maximum values. Further, the approaches detailed herein can ensure that several defined values are valid and make sense together. Moreover, it is possible to increase or decrease all values by a global translation +5 to all values, −10 to all values, etc.) moving the operator displayed in the axis. Moreover, the graphical interface can be accessed using a finger touch interface and can be customizable (e.g., predefined threshold names, predefined colors, title, minimum value, maximum value, operator to apply to values, etc.). This can be used instead of manually entering values. Particularly, this can facilitate entering the values in using a touch device, for example, a mobile touch device used in the field.

The graphical interface can display ranges along a first axis and threshold manipulation tools corresponding to the ranges. The threshold manipulation tools can be adjustable along a second axis that is perpendicular to the first axis. For example, the ranges can be shown along an X-axis and the values associated with the corresponding thresholds can be adjustable along a Y-axis.

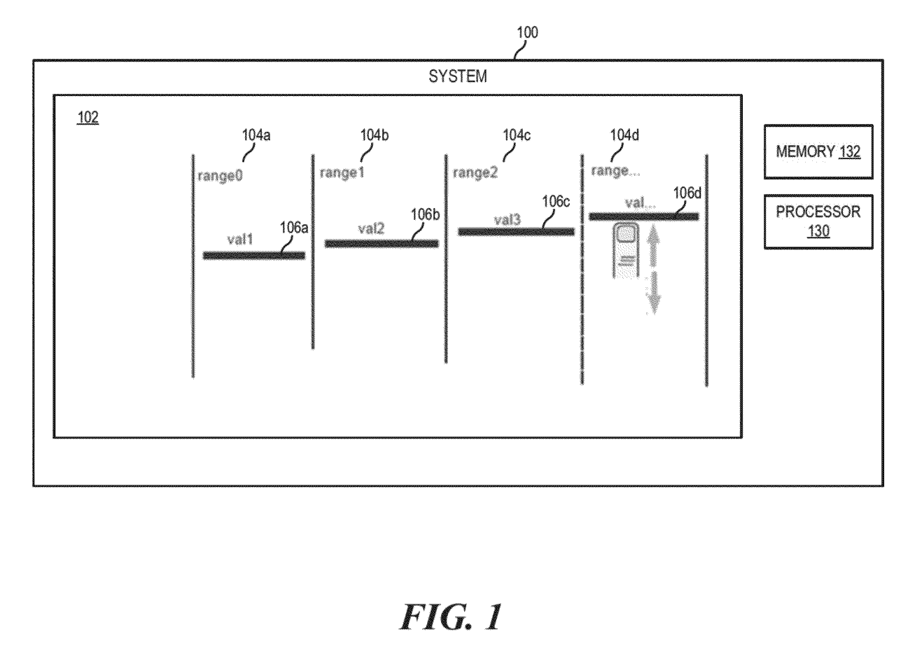

FIG. 1 is a block diagram of a system capable of editing thresholds of ranges, according to one example. In this example, the system 100 includes processor 130, memory 132, as well as instructions for performing displaying and utilizing a graphical interface at a graphical output 102, such as a projection or display. As detailed herein, system 100 may perform method 300 to show and/or use the graphical interface.

System 100 may be a notebook computer, a slate computing device, a portable reading device, a wireless email device, a mobile phone, or any other computing device. Processor 130 may be a CPU, CPU, or microprocessor suitable for retrieval and execution of instructions and/or electronic circuits configured to perform the functionality of various modules (e.g., widget module 103) described herein.

As detailed herein, system 100 may include a series of modules for causing presentation of and using the graphical interface. Each of the modules may include, for example, hardware devices including electronic circuitry for implementing the functionality described herein. In addition or as an alternative, each module may be implemented as a series of instructions encoded on a machine-readable storage medium (e.g., memory 132) of system 100 and executable by processor 130. It should be noted that, in some embodiments, some modules are implemented as hardware devices, while other modules are implemented as executable instructions.

The widget module 103 can be executed by the processor 130 to cause display of a graphical user interface to the graphical output 102. In some examples, a graphical widget is an element of a graphical user interface (GUI) that displays an information arrangement changeable by a user. In this example, the graphical widget can be used for configuring ranges 104a-104d by editing threshold values.

The graphical interface shows multiple ranges 104a-104d along a first axis (in this case the X-axis). Threshold manipulation tools 106a-106d can be used to adjust thresholds corresponding to the ranges. The threshold manipulation tools 106a-106d are adjustable along a second axis that is perpendicular to the first axis. In this case, the second axis corresponds to a Y-axis, however, it is contemplated that the first axis may be vertical and the second axis horizontal or other combinations of axis.

In some examples, range identifiers associated with the ranges 104a-104d can include a status (e.g., on target at high risk, at medium risk, at low risk, exceed, etc.), a severity (e.g., critical, major, minor, good, etc) a numerical range (e.g., a number of incidents, zero to 1000, etc a percentage range (e.g., 0%-50%-100%-150%, etc.), or the like.

Moreover, in some examples, value identifiers of values of the thresholds can represent other significance. For example, the value can be a percentage (e.g., availability>99.8%, downtime<=0.02%, a penalty, etc.), a counter (e.g., a number of incidents, a number of calls, a number of service tickets open, etc.), a value (e.g., a value computed using a rule such as average time to repair, time to close a customer call, etc.), etc. As such, in some exam pies, the values can be representative of a function of one or more threshold values associated with the ranges defined by the threshold manipulation tools 106a-106d.

Moreover, in some examples, one of the threshold manipulation tools (e.g., 106b) can adjust two thresholds. In one scenario, when the threshold manipulation tool 106b is moved, an end of range 1 and an end of range 0 may be tied together and adjusted. In another scenario, another end of range 1 and an end of range 2 may be tied together and adjusted. As such, in one example, a first one of the two thresholds can represent a low end of a first one of the ranges and a second one of the two thresholds can represent a high end of a second one of the ranges. In some examples, each of the threshold manipulation tools can adjust more than one threshold.

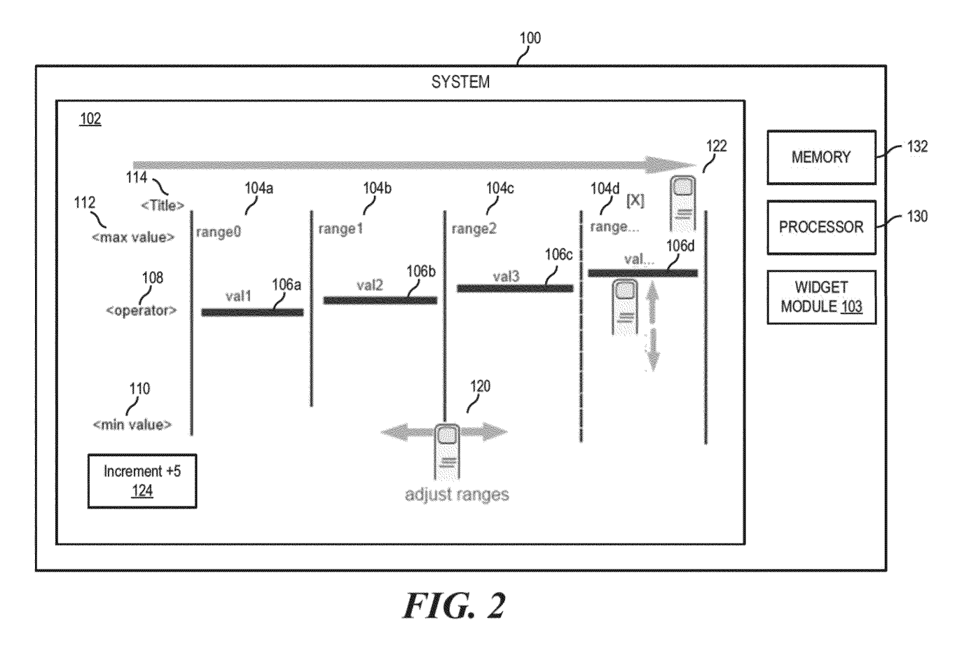

FIG. 2 is a more detailed block diagram of a system capable of editing thresholds of ranges as well as adjusting ranges, according to another example. Other user interface elements may also be included. For example, the interface can also include an operator 108. The operator 108 can represent a relationship between the ranges/values. Further, a minimum value 110 and/or a maximum value 112 of the ranges can be shown. Moreover, a title 114 or other description of the UI can be provided. The minimum and/or maximum values can represent the boundaries that are shown or the total boundaries available for an application.

Moreover, operators can be applied to enumeration that is defined. For example, if an application has an importance order, threshold values can be mapped to the statuses via enumeration. Examples of operators include less than, greater than, less than or equal to, greater than or equal to. Other operators can be defined by rules. In the example of the operator being a less than operator, the relationship with the ranges can be that the range on left side range (e.g., range 1) is lower than the threshold (e.g. threshold at 106c) to the right side (e.g., range 2). Further, the number of ranges can change.

In some examples, the graphical output 102 can be a touch-enabled display. The touch-enabled display may receive input via a touch. As such, the threshold manipulation toots can be controlled via touch input received via the touch-enabled display. The touch-enabled display can be enabled using one or more technologies, such as capacitive technology, resistive technology, surface acoustic wave technology, infrared grid technology, etc.

Touch input can also be used to adjust ranges 120. A user can touch the touch-enabled display at a range to move a first one of the ranges (e.g., range 2) with respect to a second one of the ranges (e.g., range 1) when the input is placed across the first axis (e.g., a horizontal axis 122 in this case). When this occurs, ranges can be rebalanced based on a set of rules. For example, the range 2 can take the thresholds of range 1 and range 1 can take the thresholds of range 2. Val2 and Val3 can be switched in this case, in the case of range 2 being dragged to range 0, range 2 can replace range 0, range 0 can be moved to the thresholds of range 1, with range being moved to replace range 2. In this scenario, a set of rules can be used to decide the replacements. Further, other tools can be included by the widget module 103. The example shown is to increment thresholds 124 by +5. This can be used to increase each of the thresholds, while keeping the minimum and maximum values. Other operations can be performed as well, for example, decrementing by another value, incrementing by another value, performing another function on the values, or the like.

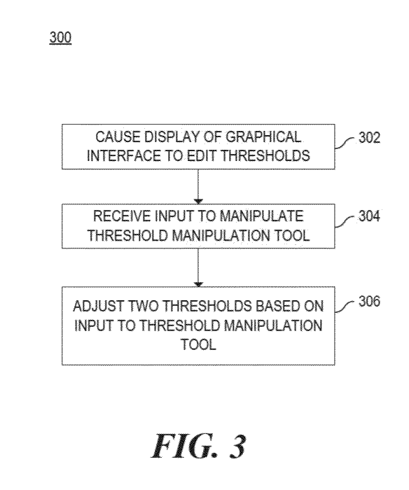

FIG. 3 is a flowchart of a method for editing thresholds, according to one example. Although execution of method 300 is described below with reference to computing system 100, other suitable components for execution of method 300 can be utilized (e.g., computing device 700). Additionally, the components for executing the method 300 may be spread among multiple devices (e.g., a processing unit and a display unit). Method 300 may be implemented in the form of executable instructions stored on a machine-readable storage medium, such as storage medium 720, and/or in the form of electronic circuitry.

Display of a graphical widget/interface can be caused by a processor of the computing system (302). The graphical widget/interface can be used to edit threshold values. The threshold values can also be presented to the user. Moreover, as detailed herein, the graphical widget/interface can show a plurality of ranges along a first axis (e.g., an X-axis) and a plurality of threshold manipulation that correspond to the ranges. In some examples, one manipulation tool can correspond to two thresholds to control a range. Moreover, manipulation of one of the thresholds can cause simultaneous changes to a first threshold of a first range and a second threshold of a second range. The value can be the same for the thresholds. The threshold manipulation tools can further be adjustable along a second axis (e.g., a Y-axis) that is perpendicular to the first axis. It is noted that it is contemplated that the axis orientation can be flip flopped.

At 304, the computing system can receive an input to manipulate a first one of the threshold manipulation tools along the second axis. Rules can be used to tie the threshold manipulation tool to two thresholds. In some cases, a threshold manipulation tool can border a fixed value (e.g., a minimum value, maximum value, etc.) and manipulates a single threshold. In this example, the input is used to manipulate two thresholds according to the rules.

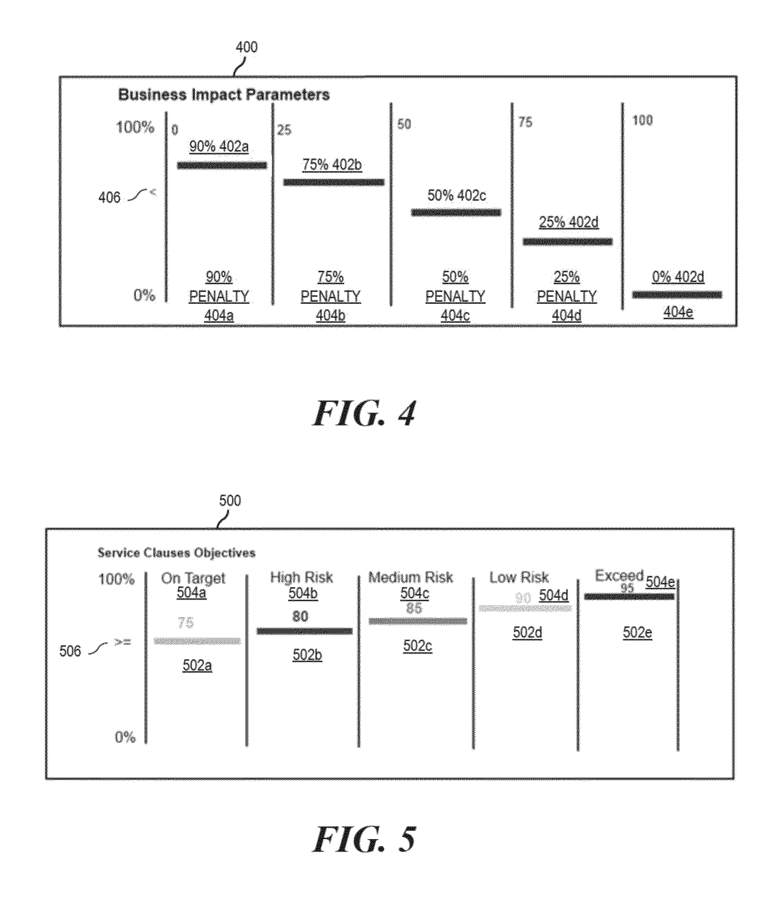

At 306, a first threshold representing a low end of a first one of the ranges and a second threshold representing a high end of a second one of the ranges is adjusted based on the input. The high end and the low end can be adjusted according to the rules. In certain examples, the rules can be customizable to represent a relationship between the first threshold and second threshold. In one example, the two thresholds can border in ranges. Further, the graphical widget/interface can display an operator that shows a relationship between the respective ranges. For example, the operator can show that the value represented by oho range is greater than or less than a threshold. As further detailed in FIGS. 4-7, the ranges can correspond to various data types, for example, at least one of a service clause objective, a service level objective, and a business impact parameter associated with availability of a clause of a service level agreement.

FIG. 4 is a block diagram of an example user interface for editing thresholds and showing ranges, according to one example. The user interface 400 can be implemented using a computing device. In this example, the data being shown is associated with business impact parameters. Business impact parameters can be considered an amount of money that a service provider would pay if a breach occurred. This can be quantified in various ways, for example, numerically, or by a percentage of the damages. Moreover, the impacts can be based on a metric. By way of example, the metric can be based on time the service is available, the number of units available, the number of units available when asked for, or the like. The metrics/ranges can be set and adjusted by a contract manager, for example, based on a contract/changes to the contract.

In this example, a service provider would pay 0% of the service fee if the associated services are between 75% and 100% of the metric, 50% if the services are between 50% and 75% of the metric, 75% if the services are between 25% and 50% of the metric, and 100% if the services are between 0% and 25% of the metric. In this scenario, the threshold manipulation tool labels 402a-402d for the business impact can be separate from ranges 404a-404e. In this scenario, the labels 402 can be tied to the respective threshold manipulation tools, but separate from the ranges 404. In this scenario, the ranges can go from 0% to 100%. If threshold manipulation tool 402a is moved, the first range 404a can be changed from 0 to 25% to 0 to X %. At the same time, the second range 404b can be changed from 25 to 50% to X to 50%. Similar manipulations can occur based on movements of the other tools. Moreover, the relationship between the ranges can be defined using an operator, in this case, the < operator 406. The operator 406 can also help show a user that the threshold manipulation tool labels 402 are different than the ranges and their respective thresholds. Being able to move the thresholds of the ranges while allowing for a separate label of the impact of the range allows for additional power at the fingertips of a contract manager. Further, information about a cost (e.g., 100%, 75%, 50%, 25%, 0%) can be displayed with associated ranges placed within a range of the corresponding threshold manipulation tool 402. Moreover, the labels 402 can be within a range of the respective threshold manipulation tools to show that the respective label is tied to the particular threshold manipulation tools.

FIG. 5 is a block diagram of an example user interface for editing thresholds and showing ranges, according to one example. The user interface 500 can be implemented using a computing device. In this example, the data being shown is associated with service clauses objectives. Service Clauses Objectives can represent an agreement of the status of a contract based on agreements. This tool can be used to ensure that the service provider does not have a service level agreement breach. Each of the categories of the ranges 504 a-504e can have separate enumerated identities. For example, range 504a can be associated with a target for an objective, range 504b can represent a high risk of breaching the target, range 504c can represent a medium risk, range 504d can represent a low risk, and range 504e can represent an exceeds expectations range. Moreover, a range between the exceeds expectations range and the maximum value can exist.

Here, threshold manipulation tools 502a-502e can be used to change ranges associated with percentages between 0 and 100% that are associated with the ranges. The greater than or equal to operator 506 can be used to show the relationships between the ranges 504. In this scenario, when the threshold manipulation tools are used and moved up or down, a corresponding label can change to correspond to a threshold. The operator 506 can show that each range to the right is greater than or equal to the threshold to the left of that range. Manipulation of the thresholds can be used to quickly adjust ranges associated with particular contracts or agreements. Moreover, a service level agreement status (e.g., on target, high risk, etc.) has an importance order, which can be associated with rules. Further, the user interface allows a dear threshold value to be associated with the respective statuses. In this example, the thresholds are shown as percentages. The percentages can be associated with a particular metric or clause, for example, network availability. Further, information about a risk (e.g., 75, 80, 85, 90, 95) can be displayed with associated ranges placed within a range of the corresponding threshold manipulation tool 502.

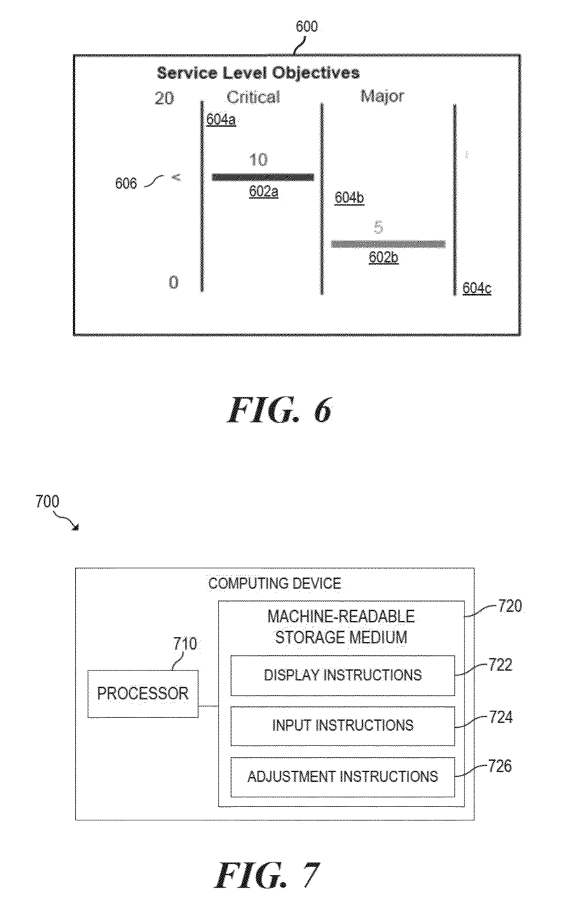

FIG. 6 is a bock diagram of an example user interface for editing thresholds and showing ranges, according to one example. The user interface 600 shows threshold values for enumerated categories, critical and major. The ranges are between a minimum of 0 and a maximum of 20. The minimum and maximum values can change based on what an administrator would like to track or based on a contract or agreement level. In this case, the ranges can represent a number of open tickets. The goal can be to have five to zero open tickets to be serviced. The operator 606 of less than can show a relationship of what the ranges 604a-604c represent. Moreover, thresholds can be changed via threshold manipulation tools 602a 602b.

The ranges associated can be no issue if less than five tickets at 604c, a major issue if the ranges are less than 10, but greater than or equal to 5 (604b), and critical if the level is greater than or equal to 10 (604a). As shown, the ranges can be visualized from left to right with the relationships based on the operator 606. Moreover, the minimum and maximum values can represent borders for ranges.

FIG. 7 is a block diagram of a computing device capable of causing display of ranges and for editing thresholds, according to one example. The computing device 700 includes, for example, a processor 710, and a machine-readable storage medium 720 including instructions 722, 724, 726 for showing a graphical interface. Computing device 700 may be, for example, a notebook computer, a slate computing device, a portable reading device, a wireless email device, a mobile phone, or any other computing device. Moreover, in some examples, the computing device can have a touch screen interface.

Processor 710 may be, at least one central processing unit (CPU), at least one semiconductor-based microprocessor, at least one graphics processing unit (GPU), other hardware devices suitable for retrieval and execution of instructions stored hi machine-readable storage medium 720, or combinations thereof. For example, the processor 710 may include multiple cores on a chip, include multiple cores across multiple chips, multiple cores across multiple devices (e.g., if the computing device 700 includes multiple node devices), or combinations thereof. Processor 710 may fetch, decode, and execute instructions 722, 724, 726 to implement display of an interface capable of showing of ranges and editing thresholds. As an alternative or in addition to retrieving and executing instructions, processor 710 may include at least one integrated circuit (IC), other control logic, other electronic circuits, or combinations thereof that include a number of electronic components for performing the functionality of instructions 722, 724, 726.

Machine-readable storage medium 720 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage. medium can be non-transitory. As described in detail herein, machine-readable storage medium 720 may be encoded with a series of executable instructions for implementing a graphical interface to facilitate entering threshold information in a database while also displaying information in an efficient manner.

The processor 710 can execute display instructions 722 of the interface to display the graphical interface for editing threshold values. Examples of the display are shown in FIGS. 1, 2, 4, 5, and 6. The graphical interface can show multiple ranges along a first axis and multiple threshold manipulation tools corresponding to the ranges. The threshold manipulation tools can be adjustable along a second axis that is perpendicular to the first axis. As such, the ranges provided for display need not be scaled to show the changes, which make the display more viewable. The processor 710 can execute input instructions 724 to receive input to manipulate the threshold manipulation tools along the second axis.

As noted, the input can be a touch enabled input. When the input is received, two thresholds of the ranges can be adjusted based on the input. The first thresholds can be associated with a first one of the ranges and the second threshold can be associated with a second one of the ranges. As such, thresholds associated with two ranges can be changed at the same time, for example via the execution of adjustment instructions 726. In one example, the first threshold can be associated with a high end of one range and the second threshold can be associated With a low end of the second range. Rules can be used to adjust relationships. Moreover, an operator can be used to show a relationship between the thresholds of the ranges. As shown in the user interfaces, the ranges can correspond to at least one of a level of risk for a service clause objective, a service level objective, a business impact parameter associated with availability of a clause of a service level agreement, or the like.

With the above approaches, the graphical interface can be used to define thresholds, for example, for entering/modifying information in an SLA. Ranges are defined using a threshold modification tool. The threshold modification tad can be a sliding user interface element. The sliding user interface element can be shown in a perpendicular direction compared to a view of ranges associated with the information. The threshold values can be mapped to multiple SLA objects (or other information). Each of the thresholds can have ranges that connect (e.g., if one range ends at 30%, the next range starts at 30%). An operator can be used to define how the ranges connect.

What is claimed is:

1. A system comprising:
at least one processor programmed to
cause display of a graphical interface for editing threshold values.
wherein the graphical interface shows a plurality of ranges along a first axis and a plurality of threshold manipulation tools corresponding to the ranges,
wherein the threshold manipulation tools are further adjustable along a second axis perpendicular to the first axis.

2. The system of claim 1, wherein the at least one processor is further programmed to:
adjust to thresholds when one of the threshold manipulation tools is used.

3. The system of claim 2, wherein a first one of the two thresholds represents a low end of a first one of the ranges and a second one of the two thresholds represents a high end of a second one of the ranges.

4. The system of claim 3, wherein the graphical interface further includes an operator that shows a relationship between the respective ranges.

5. The system of claim 2, further comprising:
a touch-enabled display,
wherein the one threshold manipulation tool is controlled via a touch input received via the touch-enabled display.

6. The system of claim 5,
wherein a second touch input received via the touch-enabled display controls movement of a first one of the ranges with respect to a second one of the ranges when the second touch input has a direction of the first axis.

7. The system of claim 5, wherein information about at least one of a risk and a cost is caused to be displayed associated with the respective ranges placed within a range of a corresponding threshold manipulation ted.

8. The system of claim 1, wherein the ranges represent at least one of a status, a severity, a numerical range, and a percentage range.

9. A non-transitory machine-readable storage medium storing instructions that, if executed by at least one processor of a device, cause the device to:
display of a graphical interface for editing threshold values,
wherein the graphical interface shows a plurality of ranges along a first axis and a plurality of threshold manipulation tools corresponding to the ranges,
wherein the threshold manipulation tools are further adjustable along a second axis perpendicular to the first axis;
receive a touch input to manipulate a first one of the threshold manipulation tools along the second axis; and
adjust two thresholds of the ranges based on the touch input.

10. The non-transitory machine-readable storage medium of claim 9, wherein a first one of the two thresholds represents a low end of a first one of the ranges and a second one of the two thresholds represents a high end of a second one of the ranges.

11. The non-transitory machine-readable storage medium of claim 9, wherein the graphical interface further includes an operator that shows a relationship between the respective ranges.

12. The non-transitory machine-readable storage medium of claim 9, wherein the ranges correspond to at least one of: a level of risk for a service clause objective, a service level objective, and a business impact parameter associated with availability of a clause of a service level agreement.

13. A method comprising:
causing display of a graphical interface to edit threshold values,
wherein the graphical interface shows a plurality of ranges along a first axis and a plurality of threshold manipulation tools corresponding to the ranges,
wherein the threshold manipulation tools are further adjustable along a second axis perpendicular to the first axis;
receiving an input to manipulate a first one of the threshold manipulation tools along the second axis; and
adjusting a first threshold representing a low end of a first one of the ranges and a second threshold representing a high end of a second one of the ranges based on the input.

14. The method of claim 13, wherein the graphical interface further includes an operator that shows a relationship between the respective ranges.

15. The method of claim 13, wherein the ranges correspond to at least one of: a level of risk for a service clause objective, a service level objective, and a business impact parameter associated with availability of a clause of a service level agreement.
